(19) United States
(12) Patent Application Publication
(10) Pub. No.: US 2005/0249622 A1
(43) Pub. Date: Nov. 10, 2005

(54) Device for controlling parasitic losses in a fluid pump

(76) Inventor: Michael C. Sefcik, Linden, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/110,476

(22) Filed: Apr. 20, 2005

Related U.S. Application Data
(60) Provisional application No. 60/563,694, filed on Apr. 20, 2004.

(51) Int. Cl. F03C 2/00; F04C 2/00

(52) U.S. Cl. 418/19; 417/310

(57) ABSTRACT

A device for reducing parasitic loss of a fluid pump is accomplished by connecting the power supply driveshaft to the drive pump element through a clutch element. The clutch element engages the drive pump element and frictionally engages the driveshaft so that at or above a predetermined fluid pressure, the clutch element releases the driveshaft so the driveshaft rotates within the clutch element thereby halting the pumping action of the pump. When the fluid pressure drops below a predetermined fluid pressure, the clutch element reengages the driveshaft to resume the pumping action.

### CROSS-REFERENCE TO RELATED APPLICATION

This application claims the benefit of priority from U.S. Provisional Patent Application No. 60/563,694 filed on Apr. 20, 2004.

### FIELD OF THE INVENTION

The present invention relates generally to fluid pumps, and more particularly, to a device for controlling parasitic losses in a fluid pump.

### BACKGROUND

There are numerous uses for fluid pumps across a wide range of industries. One such industry requiring fluid pumps is the automotive industry. In particular, a combustion engine vehicle includes an engine lubrication system designed to deliver clean oil at the correct temperature and pressure to the engine. The heart of the system is the oil pump that pumps oil from the oil reservoir through a simple wire screen to strain out any big chunks and feds the oil through a filter to clean the oil. The oil is then pumped to different parts of the engine to assist in cooling and lubrication and then falls to the bottom of the engine crankcase—the oil reservoir, to continue the process.

One particular type of pump mechanism typically used in combustion engine vehicle oil pumps is the gerotor pump. Gerotor pumps are positive displacement pumps using nested hypocycloid gear elements as their pumping elements. The inner-toothed gear element, also called a pinion gear, meshes with and is located inside of the outer-toothed gear element, also called a ring gear. These elements are supported on a pump housing for rotation about parallel, laterally separated centerlines. In a gerotor pump, either the inner or the outer element is driven by a motor, and this element then drives the other. These gear elements rotate relative to each other to create a pumping action.

Since the outer gear element has one more tooth than the inner gear element, and both elements are mounted on fixed centers eccentric to each other, a one-tooth volume is opened and closed across each rotation. As the toothed elements turn, the chamber between the teeth of the inner and outer gear elements gradually increases in size through approximately 180° of each revolution until it reaches its maximum size—equivalent to the full volume of the “missing tooth”. During this initial half of the cycle, the gradually enlarging chamber is exposed to the inlet port of the pump housing creating a partial vacuum into which the oil flows. During the subsequent 180° of the revolution, the chamber gradually decreases in size as the teeth mesh and the liquid is forced out through the discharge port of the pump housing. Therefore, rotation movement of the pumping elements creates a pumping action.

Oil pumps are designed to deliver oil in greater quantities and pressures than the engine actually requires. For example, when the inner gear element drives the gerotor pump, that inner drive element is coupled to the driveshaft so that the oil pump runs continuously while the engine is running. The gerotor will deliver a known, predetermined quantity of fluid in proportion to the speed of the input power. Such a continuously running oil pump provides consistently greater quantities of oil and oil pressure to the engine than are actually required. Constant oil pressure is maintained and additional oil pressure not required is vented off. Such continuous running of the oil pump promotes parasitic loss and adds to the additional wear and tear on the oil pump and its system.

There is a constant need in the art to make engines and their components and systems more efficient and more durable.

### SUMMARY OF THE PRESENT INVENTION

The present invention seeks to reduce parasitic loss of a fluid pump by selectively running the pump only when needed. While the present invention is described herein with reference to the preferred embodiment of using the invention with the gerotor oil pump of an internal combustion engine, it should be clear that the present invention can be utilized by any fluid pump powered by an input driveshaft.

The present invention reduces oil pressure capacity once the minimum volume is achieved thereby limiting pumping losses to a fixed level. Therefore, once the minimum oil volume and oil pressure are achieved, the input power supply disengages from the oil pump so that the oil pump does not continuously run. There are numerous benefits to limiting the output flow, such as, increasing the life expectance of the rotor due to a reduction in cavitation from high speed operation, reducing heat generation because the pump only pumps the required flow, and increased filter life or reduced filter size required due to reduced volumes of oil being filtered. When the oil volume and oil pressure reduce to a minimum level, the input power supply re-engages the oil pump to run the oil pump until a threshold is achieved.

A device for reducing parasitic loss of a fluid pump according to the present invention is accomplished by connecting the power supply driveshaft to the drive pump element through a clutch element. The clutch element engages the drive pump element and frictionally engages the driveshaft so that at or above a predetermined fluid pressure the clutch element releases the driveshaft so the driveshaft rotates within the clutch element thereby halting the pumping action of the pump. When the fluid pressure drops below a predetermined fluid pressure, the clutch element reengages the driveshaft to resume the pumping action.

### BRIEF DESCRIPTION OF THE SEVERAL VIEWS OF THE DRAWING

Objects and advantages together with the operation of the invention may be better understood by reference to the following detailed description taken in connection with the following illustrations, wherein:

FIG. 1 shows an oil pump assembly according to the preferred embodiment of the present invention.

FIG. 2 shows a partial cross-sectional view of the oil pump assembly of FIG. 1.

FIG. 3 shows the interaction between the clutch element 15, the pump drive element 13, and the pump driven element 12.

FIG. 4 shows the interaction between the clutch hub or shaft 16 and the clutch element 15.

FIG. 5 shows the clutch element 15.

FIG. 6 shows an exploded view of the clutch element and pump drive element component.

### DETAILED DESCRIPTION OF THE INVENTION

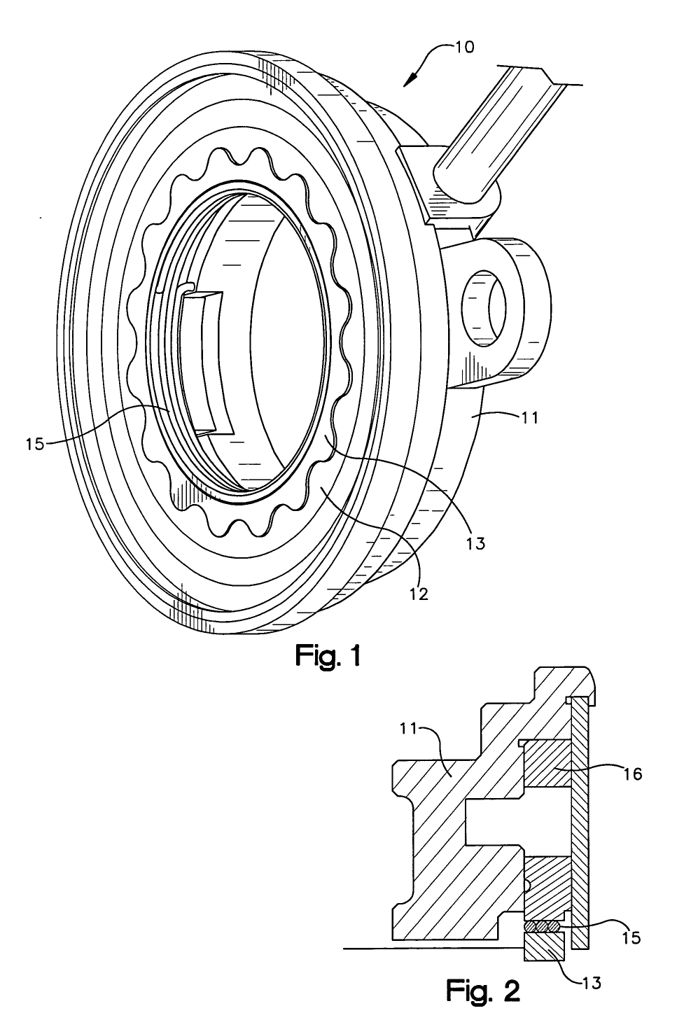

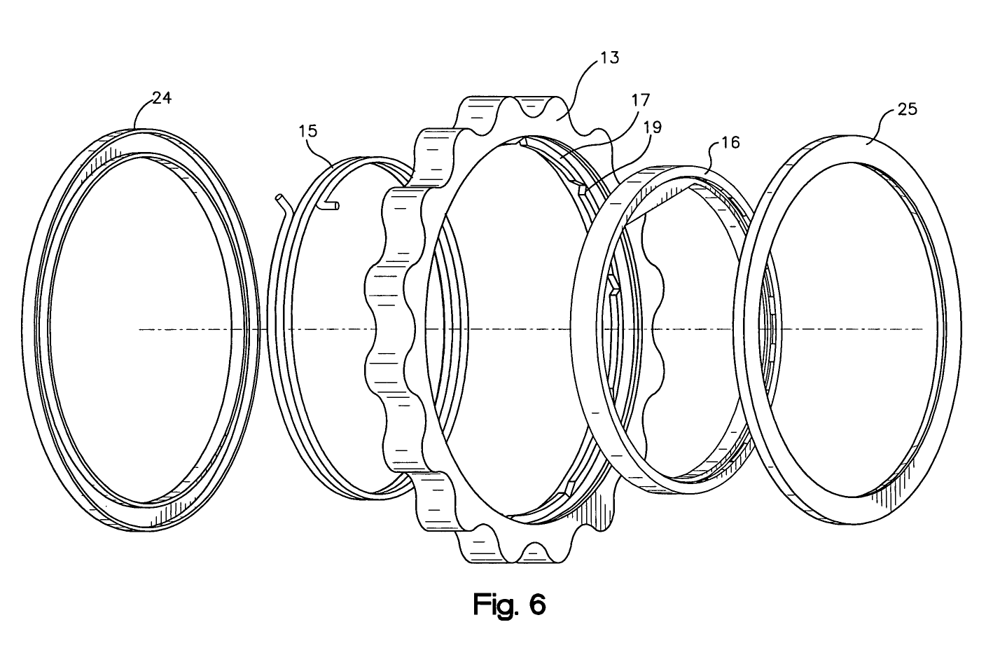

The present invention will now be described in accordance with the preferred embodiment as shown in FIGS. 1 through 6. An oil pump assembly 10 generally comprises a pump housing 11, a driven pumping element 12, a drive pumping element 13, and a clutch element 15. Power is input into the oil pump assembly 10 by a driveshaft connected to the engine to provide power while the engine is running.

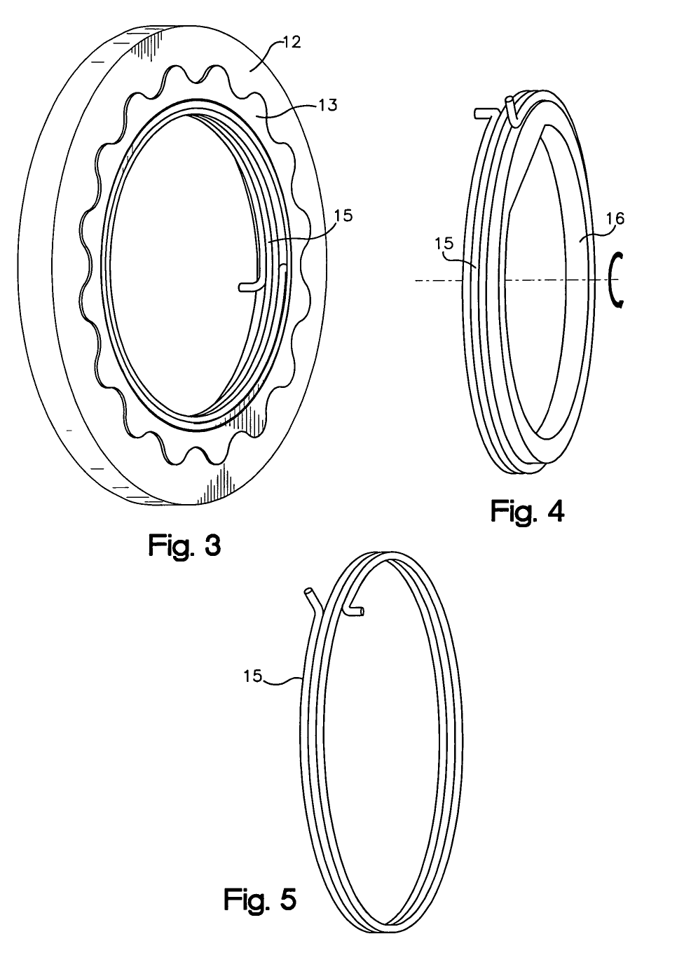

The input power driveshaft (not shown) can either be connected to a clutch hub 16, as shown in FIG. 4, which frictionally engages the clutch element 15 or the driveshaft can directly frictionally engage the clutch element 15 as provided in FIG. 3. For the purposes of this disclosure and the claims, the driveshaft and any element connected to the driveshaft that frictionally engages the clutch element will be referred to as the driveshaft.

As viewed in FIG. 4, the driveshaft is driven in a clockwise fashion and frictionally engages the clutch element 15 so as to tighten the clutch element 15. It is preferred that the clutch element 15 be a coil spring located coaxially about the driveshaft and annularly between the driveshaft and the drive pumping element aperture 17. Therefore, during rotation of the driveshaft, the tightening of the coil spring creates an increased frictional engagement between the driveshaft and clutch element 15 and thereby imparts a force on the inner drive element 13. The clutch element 15 engages the pump drive element 13 at one end, as best shown in FIG. 3 and frictionally engages the driveshaft at the other end. The pump drive element 13 rotates and drives the pump driven element 12 through associated gear teeth to cause a pumping action.

The oil pump assembly 10 operates to provide the engine with a predetermined volume and pressure of oil. When that predetermined volume and pressure are met, the driven element 12 exerts a resistance force on the drive element 13, which in turn exerts a resistance force on one end of the clutch element 15. The resistance force acting upon one end of the clutch element 15 urges the clutch element 15 to unwind causing the clutch element 15 to lose frictional contact with the driveshaft. Therefore, when the predetermined oil volume and pressure are achieved, the driveshaft slips relative to the clutch element 15 thereby causing the driveshaft to rotate within the clutch element 15 and provide no input power to operate the drive pumping element 13 of the oil pump.

When the resistance force diminishes, i.e. the oil pump volume and pressure are reduced to below the required value, the clutch member reengages the driveshaft thereby reestablishing the frictional engagement required to drive the drive pumping element 13 to resume the pumping action.

As best shown in FIG. 6, inner pinion gear aperture 17 includes at least one notch 19 therein capable of engaging one end of the coil spring so as to prevent rotation of the coil spring in a first rotational direction. Preferably, the inner pinion gear aperture 17 includes a plurality of notches 19 therein capable of engaging one end of said coil spring so as to prevent rotation of the coil spring in the first direction and permitting articulated rotation of the coil spring in the opposite rotational direction. Therefore, the inner pinion gear 13 is easier to assembly onto a driveshaft.

Finally, it is noted that in the presently preferred embodiment, two annular support members 25 are positioned on either side of the inner pinion gear 13 to maintain the coil spring 15 between the driveshaft and the inner pinion gear aperture 17. However, other structures could be utilized to perform this function.

While the invention has been described with reference to the preferred embodiment, other embodiments, modifications, and alternations that occur to one skilled in the art upon reading and understanding of this specification are covered to the extent that they fall within the scope of the appended claims.

1. A device for controlling parasitic loss in a fluid pump having a drive pump element driven by a driveshaft, said device comprising:
a clutch element engaging said drive pump element and frictionally engaging said driveshaft; and
wherein at or above a predetermined fluid pressure said clutch element releases said driveshaft so that said driveshaft rotates within said clutch element thereby halting said pumping action until the fluid pressure drops below said predetermined fluid pressure and said clutch element reengages said driveshaft to resume said pumping action.

2. The device of claim 1 wherein said clutch element comprises a coil spring.

3. The device of claim 2 wherein said coil spring is located coaxially about said driveshaft.

4. The device of claim 3 wherein said drive pump element includes an aperture therein for receipt of said driveshaft, where said coil spring is located annularly between said driveshaft and said aperture.

5. The device of claim 3 wherein said fluid is oil.

6. The device of claim 1 wherein said drive pump element includes an aperture therein for receipt of said driveshaft, where said clutch element is located annularly between said driveshaft and said aperture.

7. The device of claim 6 wherein said fluid is oil.

8. A pump assembly comprising:
a pump housing;
a driven pumping element located within said housing and rotatable therein;
a drive pumping element located inside of said driven pumping element and rotatable therein, said drive pumping element having an aperture therethrough capable of connection to a driveshaft for providing power to said drive pumping element which in turn causes rotation of said driven pumping element wherein the movement between said drive pumping element and said driven pumping element causes a pumping action;
a clutch element engaging said drive pump element and releasably engaging said driveshaft; and
wherein at or above a predetermined fluid pressure said clutch element releases said driveshaft so that said driveshaft rotates within said clutch element thereby halting said pumping action until the fluid pressure drops below said predetermined fluid pressure and said clutch element reengages said driveshaft to resume said pumping action.

9. The pump assembly of claim 8 wherein said releasable connection is a frictional connection.

10. The pump assembly of claim 9 wherein said clutch element is located annularly between said driveshaft and said aperture.

11. The pump assembly of claim 10 wherein said clutch element is located coaxially about said driveshaft.

12. The pump assembly of claim 11 wherein said clutch element comprises a coil spring.

13. The pump assembly of claim 12 wherein said driven pumping element is an outer ring gear.

14. The pump assembly of claim 13 wherein said drive pumping element is an inner pinion gear.

15. The pump assembly of claim 14 wherein said fluid is oil.

16. An oil pump assembly for an internal combustion engine driven by the driveshaft of said internal combustion engine, the assembly comprising:
a pump housing having an oil inlet and an oil outlet;
an outer ring gear located within said housing and rotatable about a first centerline;
an inner pinion gear located inside of said ring gear and rotatable about a second centerline parallel to and separated from said first centerline so that a crescent-shaped cavity is defined between said ring gear and said pinion gear, said inner pinion gear having an aperture therethrough capable of connection to a driveshaft for providing rotational input power to said inner pinion gear which in turn causes rotation of said outer ring gear
wherein the movement between the inner and outer gears causes a pumping action of oil from said oil inlet to said oil outlet;
a clutch element located annularly between said driveshaft and said inner pinion gear aperture and releasably connected to said driveshaft;
wherein below a predetermined oil pressure said clutch element transmits input power from said driveshaft to said inner pinion gear to cause said pumping action; and wherein at or above a predetermined oil pressure said clutch element releases said driveshaft so that said driveshaft rotates within said clutch element thereby halting said pumping action until the oil pressure drops below said predetermined oil pressure and said clutch element reengages said driveshaft to resume said pumping action.

17. The oil pump assembly of claim 16 wherein said clutch element comprises a coil spring.

18. The oil pump assembly of claim 17 wherein said coil spring is located coaxially about said driveshaft.

19. The oil pump assembly of claim 18 wherein said inner pinion gear aperture includes at least one notch therein capable of engaging one end of said coil spring so as to prevent rotation of said coil spring in a first rotational direction.

20. The oil pump assembly of claim 19 wherein said inner pinion gear aperture includes a plurality of notches therein capable of engaging one end of said coil spring so as to prevent rotation of said coil spring in a first direction and capable of articulated rotation in an opposite rotational direction.
